(19) United States
(12) Patent Application Publication
(10) Pub. No.: US 2019/0084612 A1
(43) Pub. Date: Mar. 21, 2019

(54) Belt Drive and Steering System

(71) Applicant: Robert Bosch Automotive Steering GmbH, Schwäbisch Gmünd (DE)

(72) Inventors: Artur Kirschenmann, Stuttgart (DE); Gerd Speidel, Winterbach (DE)

(21) Appl. No.: 16/078,440

(22) PCT Filed: Dec. 6, 2016
(86) PCT No.: PCT/EP2016/079821

§ 371 Date: Aug. 21, 2018

(30) Foreign Application Priority Data
Feb. 24, 2016 (DE) 10 2016 103 197.6

(51) Int. Cl. B62D 5/04; F16H 7/08

(52) U.S. Cl. CPC B62D 5/0427; F16H 2007/0825; F16H 7/08

(57) ABSTRACT

A belt drive has a drive gear, an output gear, a tensioning gear, and at least two belts. Each belt partly loops the drive gear and the output gear, and a strand of each belt partly loops the tensioning gear. A strand of a first belt loops the tensioning gear in one circumferential direction. This strand extends from the drive gear to the output gear. A strand of a second belt loops the tensioning gear in the other circumferential direction. This strand extends from the drive gear to the output gear. This belt drive achieves a large looping angle for the drive gear and the output gear, and correspondingly, a large transmission power. Additionally, the effect of the other belt enables a belt self-tensioning function which is independent of the rotational direction. Guiding the belts in this manner enables omission of an additional mounting of the tensioning gear.

The invention relates to a belt drive and to a steering system having such a belt drive.

A belt drive is used for example in an electric power steering system in order to transmit drive power of a drive motor—designed for example as an electric motor which acts in support of torque which is transmitted by an operator via a steering handling means, and especially via a steering wheel, to a steering shaft—to said steering shaft or to a steering rod.

In the case of such power steering systems, belt drives are frequently used in order to transmit a provided torque in a sufficiently reliable manner even with relatively low belt tensions and small wrap angles (and therefore small diameters of the drive gears and driven gears). A disadvantage of this, however, is the noise development which ensues as a result of the toothing of the toothed belt during operation.

It is known to tension belt drives by means of a tensioning gear, which acts especially upon the slack strand (cf. for example DE 41 14 477 A1), in order to ensure a sufficient application pressure between the belts and the wrapped around circumferential sections of the drive gears and the driven gears and therefore to ensure the transmission of provided torque and—in the case of toothed belts—a reliable tooth meshing even in the case of a lengthening of the belts occurring during operation. Furthermore, such tensioning gears reduce vibrations of relatively long strands of the belt drive.

A power steering system, in which a flat belt is used for transmitting the drive power of an electric drive motor, is known from EP 1 777 140 A1. In the case of this power steering system, moreover, instead of a conventional tensioning gear which bears pressure upon the slack strand of the belt in the direction of the load strand use is made of a tensioning gear which is supported between the slack strand and the load strand and forces these away from each other as a result of a suitable diameter dimensioning in order to achieve the tensioning effect. Specified as an essential advantage of such a tensioning gear is the fact that an additional support for this can be dispensed with since the tensioning gear automatically remains in position as a result of the contact with both the slack strand and the load strand.

A disadvantage of the belt drive known from EP 1 777 140 A1 is that as a result of the arrangement there of the tensioning gear the angle of wrap of the drive gear and the driven gear is relatively small as a consequence of the pressure of slack strand and load strand being directed away from each other, as a result of which the degree of transmissible drive power is correspondingly also reduced. This is particularly a problem when using the belt drive, also provided in EP 1 777 140 A1, in a power steering system because with a conventional flat belt gear (with conventional tensioning gear), with sensible dimensioning of the drive gear and driven gear and also of the belt tension (and therefore of the mountings of the gears), a reliable transmission of sufficiently large torque for the intended function is already not possible.

Starting from this prior art, the invention has been based on the object of specifying a belt drive, which is provided especially for use in a steering system for a motor vehicle, which with appropriately small dimensioning enables transmission of relatively high drive power outputs. The belt drive which is to be specified should preferably also be distinguished by a low-noise operation as far as possible.

This object is achieved by means of a belt drive according to patent claim 1. A steering system for especially a motor vehicle having such a belt drive is the subject matter of patent claim 8. Advantageous embodiments of the belt drive according to the invention and of the steering system according to the invention are the subjects of the further patent claims and are gathered from the subsequent description of the invention.

A belt drive according to the invention comprises at least one drive gear, a driven gear and a tensioning gear (arranged between the drive gear and the driven gear) and is furthermore characterized by at least two belts which in each case partially wrap around the drive gear, the driven gear and, by one strand in each case (guided between the drive gear and the driven gear), wrap around the tensioning gear, wherein a first belt, by the associated strand which extends in a direction for example from the drive gear to the driven gear, wraps around the tensioning gear in one circumferential direction, and a second belt, by the associated strand which extends in the same direction, i.e. again for example from the drive gear to the driven gear, wraps around the tensioning gear in the other circumferential direction.

In this way, a wrapping around of the tensioning gear by the belts in different circumferential sections ensues, as a result of which a number of advantages can be realized.

A particularly relevant advantage of this type of wrapping around of the tensioning gear by the belts lies in the fact that consequently the wrapping around both of the drive gear and the driven gear, for geometric reasons, is significantly increased in comparison to a conventional belt drive with a tensioning gear which sinks into the slack strand of a belt from the outside and no longer in comparison to the belt drive known from EP 1 777 140 A1, as a result of which the drive power which can be transmitted by means of the belt drive can also be increased to a corresponding degree without the diameters of the drive gear and driven gear having to be increased for it.

This advantage has an advantageous effect especially in the case of belt drives of which the belts are of toothless design because with these the transmission of drive power is carried out exclusively in a frictionally engaging manner. An advantage of such belt drives with toothless belts lies in the relatively low-noise operation so that for a belt drive according to the invention, which is intended to be distinguished not only by a relatively large transmissible drive power but also by a low-noise operation, toothless belts and especially flat belts can preferably be provided. Alternatively to flat belts, however, other toothless belts, such as in particular V-belts, V-ribbed belts and/or round belts, can also be used.

A further advantage, which results from the type of wrapping around according to the invention of the tensioning gear by the belts, lies in the fact that consequently the tensioning gear is retained inside the strands of the belts which wrap around this, as a result of which an additional support for the tensioning gear can be designed in a comparatively simple manner or such an additional support can especially preferably be dispensed with altogether. In the case of such an especially preferred embodiment of the belt drive according to the invention, the tensioning gear is accordingly supported exclusively by the belts. This enables a particularly inexpensive embodiment for the belt drive according to the invention.

An additional support for the tensioning gear can be dispensed with especially when the belt drive according to the invention comprises at least two first belts and one or more second belts, wherein two first belts encompass the second belt(s) with regard to the longitudinal direction (direction of rotational axis) of the tensioning gear, i.e. are arranged on the outside of these on both sides. In this way, compensation of the tilting moments (around an axis located centrally with regard to the longitudinal extent of the tensioning gear and also perpendicular to the rotational axis) which the strands of the belts which wrap around the tensioning gear eccentrically create (with regard to the longitudinal extent of the tensioning gear), can be achieved.

For a support of the tensioning gear exclusively by the belts, an advantageous effect can also be had inter alia if the contact areas, which on the one hand are formed in each case between the tensioning gear, the drive gear and/or the driven gear and also the first belt(s), and on the other hand are formed in each case between the tensioning gear, the drive gear and/or the driven gear and also the second belt(s), are of equal size (when the belt drive is not in operation) since the sizes of these contact areas are proportional to the radially directed forces exerted by the belts upon the tensioning gear and therefore also to the tilting moments which are possibly induced as a result of these forces. Such an embodiment of the belt drive according to the invention can, moreover, have an advantageous effect with regard to a uniform lengthening of the belts during operation and also with regard to the transmission of drive outputs of equal magnitude in the two rotational directions.

A further advantage, which results from the type of wrapping around according to the invention of the tensioning gear by the belts, lies in the self-tensioning of the belts in relation to each other via the tensioning gear which for one thing is independent of the rotational direction of the drive gear. Therefore, in a preferred embodiment of the belt drive according to the invention it can also be provided to use a drive motor, coupled to the drive gear, which is intended for an operation in both rotational directions.

It is also advantageous that the self-tensioning effect of the belts in relation to each other is also dependent upon the transmitted drive power and can also compensate a possibly variable lengthening of the belts during operation.

A steering system according to the invention, which is especially intended for a motor vehicle, comprises at least one steering rod, which is provided with one or more connecting elements (especially track rod ends) which are provided for a (preferably rotatable) connection to (in each case) a steering lever of a steerable wheel (of the motor vehicle), and furthermore has a steering drive, acting directly or indirectly upon the steering rod, which has a drive motor, especially an electric motor (possibly even a hydraulic motor), and a belt drive according to the invention.

In the case of the steering system according to the invention, it can preferably be a power steering system in which the drive power of the steering drive has an assisting effect upon a steering force which is exerted manually by an operator of the steering system upon the steering rod. The steering system, however, can also be designed in such a way that the drive power created by the steering drive brings about the steering movement of the wheel(s) on its own or in combination with an additional steering drive.

The steering system according to the invention can also preferably comprise a steering shaft which is connected via a gear to the steering rod in such a way that a rotation of the steering shaft leads to a longitudinal axial translation of the steering rod. Such a steering system can preferably be designed as a power steering system when a steering handling means, especially a steering wheel, is additionally connected to the steering shaft in a rotation-resistant manner. Alternatively or additionally, it can also be provided to allow the steering drive or an additional steering drive to interact with the steering shaft. Providing the steering drive which comprises a belt drive according to the invention acts upon the steering shaft, this acts indirectly upon the steering rod.

A steering drive which acts directly upon the steering rod can for example additionally comprise a (ball) spindle nut, serving as a driven gear of the belt drive according to the invention, which interacts with a spiral groove in the steering rod in order to convert a rotation of the (ball) spindle nut, effected by the drive motor and the belt drive, into a longitudinal axial translation of the steering rod.

The indefinite article (“a”), especially in the patent claims and in the description generally explaining the patent claims, are to be understood as such and not as numerals. Accordingly, components which are specified by this are therefore to be understood so that these are present at least once and can be present more than once.

The invention is explained in more detail below based on exemplary embodiments which are represented in the drawings. In the drawings:

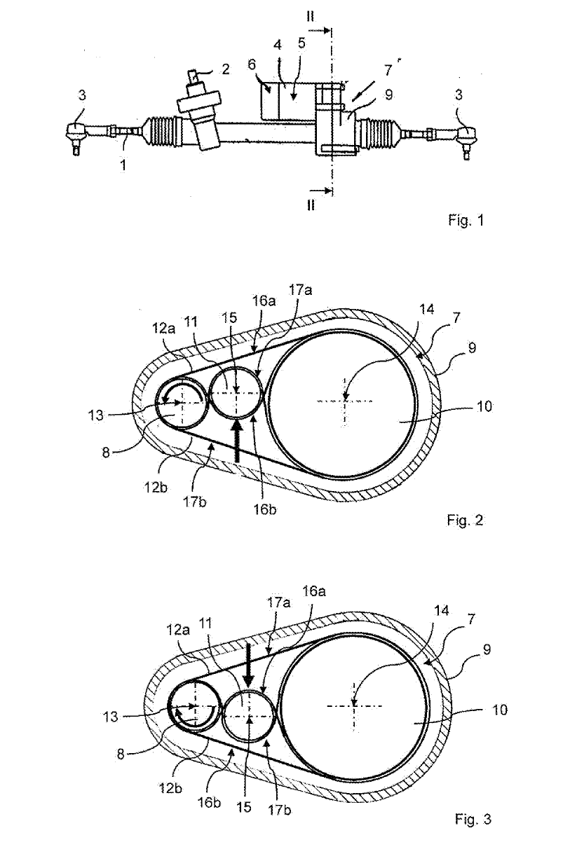

FIG. 1: shows a steering system according to the invention in a side view;

FIG. 2: shows in a simplified view a section through the belt drive of the steering system along the sectional plane II-II in FIG. 1 during an operation in one of the rotational directions;

FIG. 3: shows the sectional view according to FIG. 2 during an operation of the belt drive in the other rotational direction;

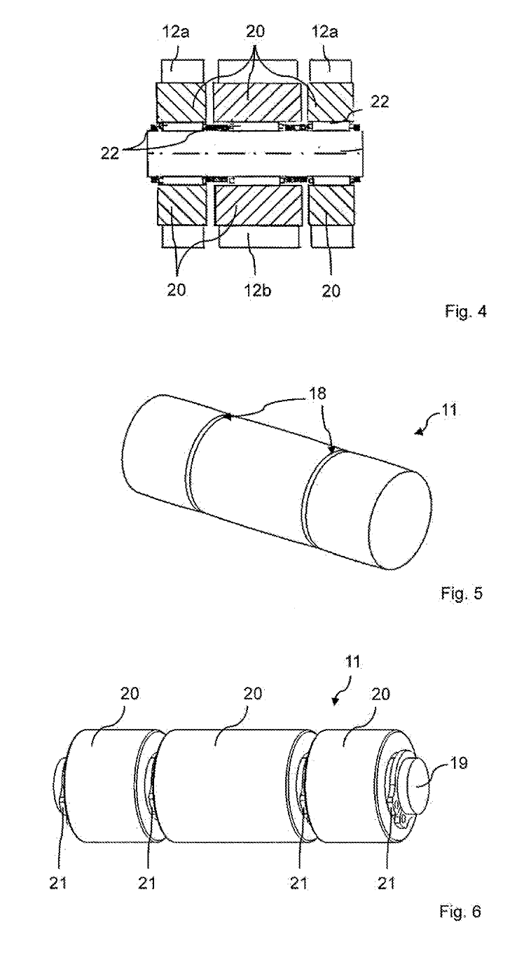

FIG. 4: shows a section through the tensioning gear and the belts of the belt drive which partially wrap around this;

FIG. 5: shows a possible embodiment of the tensioning gear in a perspective view and

FIG. 6: shows an alternative embodiment of the tensioning gear in a perspective view.

The steering system shown in FIG. 1 represents an electric power steering system for example for a private motor vehicle which is otherwise not shown.

This steering system comprises a steering rod 1 which in one section is designed as a toothed rack. Meshing with the toothing (not visible) of the steering rod 1 is a steering pinion (not visible) which is connected in a rotation-resistant manner to the steering spindle 2. The steering spindle 2 in turn serves for the rotation-resistant connection to a steering shaft, not shown, and to the steering wheel, connected thereto, of the private motor vehicle. Arranged at both ends of the steering rod 1 are track rod ends 3 which are provided for connecting to wheel steering levers (not shown). By means of the wheel steering lever a longitudinal axial translation of the steering rod 1 is converted into a pivoting movement of the steered wheels (not shown) of the private motor vehicle.

The steering system also comprises a steering drive 5 which is based on an electric motor 4. In dependence upon the steering torque, which a driver of the private motor vehicle exerts upon the steering wheel and therefore upon the steering shaft, the electric motor 4 of the steering drive 5, controlled by a control unit 6, creates an assisting power steering torque with variable value. This assisting power steering torque or the rotational movement of a rotor (not visible) of the electric motor 4 provided for it is stepped down onto the steering rod 1 by means of a belt drive 7 according to the invention and a further gear (not visible), for example a ball spindle drive, in which the steering rod 1 is provided with a spiral nut in which engage balls of a spindle nut which serves as a driven gear of the belt drive 7 or is connected to such a driven gear.

FIGS. 2 and 3 show in each case in a simplified view a section through the belt drive 7 of the steering system according to FIG. 1, wherein the views with regard to the rotational direction of a drive gear 8 (i.e. of a pinion connected in a rotation-resistant manner to the rotor of the electric motor) and therefore of the entire belt drive 7 differ from each other.

The belt drive 7 which is arranged inside a housing 9 of the steering system, in addition to the drive gear 8 and the driven gear 10 (spindle nut of the ball spindle drive) which is arranged axially parallel thereto, additionally comprises a tensioning gear 11 arranged between the drive gear 8 and the driven gear 10 and also two belts 12a, 12b which partially wrap around the drive gear 8, the driven gear 10 and the tensioning gear 11 and which in the present exemplary embodiment are designed as flat belts, as a result of which a particularly low-noise operation can be realized for the steering system.

As gathered from FIG. 4, in the present exemplary embodiments provision is made for three belts 12a, 12b of which two, as first belts 12a, by one of their strands and for example coming from the drive gear and leading to the driven gear with regard to an extent direction, wrap around the tensioning gear 11 in one of its circumferential directions (clockwise in FIGS. 2 and 3), whereas a single belt, as a second belt 12b, also by one of its strands (which with regard to the strand of the first belt 12a which wraps around the tensioning gear 11 connects the drive gear and the driven gear on the opposite side with regard to the rotational axes 13, 14 of these gears 8, 10), with regard to the same extent direction, that is to say also coming from the drive gear 8 and leading to the driven gear 10, wraps around the tensioning gear 11 in the other circumferential direction (anticlockwise in FIGS. 2 and 3).

As a result of the reverse wrapping around of the tensioning gear 11, arranged between the drive gear 8 and the driven gear 10, by the belts 12a 12b, the effect of the individual belts 12a, 12b wrapping around the drive gear 8 and the driven gear 10 in each case over a comparatively large wrap angle of approximately 270° is achieved on the one hand, as a result of which a correspondingly large contact area between the belts 12a, 12b on the one hand and the drive gear 8 and the driven gear 10 on the other hand is realized in each case, which in the case of a flat belt drive which acts purely in a frictionally engaging manner leads to a correspondingly greater transmissible torque.

Furthermore, as a result of the guiding of the belts 12a, 12b according to the invention a wrapping around of the tensioning gear 11 of approximately 360° by the belts 12a, 12b in combination is achieved, as a result of which this tensioning gear can be reliably supported exclusively by the belts 12a, 12b without an additional support on for example the housing 9 of the steering system being necessary for it.

As a consequence of the longitudinal axial offset of the respective wrapping around of the tensioning gear 11 by the two first belts 12a these create in each case a tilting moment around an axis which extends centrally with regard to the longitudinal extent of the tensioning gear 11 and perpendicularly to its longitudinal axis 15. Since the two first belts 12a, however, have coinciding belt widths, coinciding wrap angles and coinciding distances to this axis, but in this case are arranged on different sides with regard to this axis, the tilting moments created by these are compensated so that despite the absence of an additional support for the tensioning gear 11 a tilt-stable position with basically axially parallel alignment in relation to the rotational axes 13, 14 of the drive gear 8 and the driven gear 10 ensues. As a result of its central arrangement with regard to the longitudinal extent of the tensioning gear 11, basically no tilting moment around the corresponding axis is created by the second belt 12b.

As a result of the wrapping around according to the invention of the tensioning gear 11 by means of the belts 12a, 12b, these, moreover, are self-tensioned, i.e. as a result of the respective effect of the other (first or second) belt(s). In this case, the tensioning effect is dependent on rotational direction, as is evident especially from FIGS. 2 and 3.

FIG. 2 shows a rotation of the drive gear 8 and therefore also of the driven gear 10 in the anticlockwise direction, as a result of which those strands of all the belts 12a, 12b, which with regard to the rotational axes 13, 14 of the drive gear 8 and the driven gear 10 connect the drive gear 8 and the driven gear 10 on the side located at the top in FIG. 2, constitute load strands 16a, 16b which primarily transmit the drive power, which is transmitted by the electric motor 4 to the drive gear 8 in the form of torque, to the drive gear 8. This drive power effects a significant tension inside these load strands 16a, 16b, as a result of which the load strand 16b of the second belt 12b, which with regard to the rotational axis 15 wraps around the tensioning gear 11 on the side which is distant from the load strands 16a of the two first belts 12a, acts upon the tensioning gear 11 in the direction of the load strands 16a of the two first belts 12a (i.e. toward the top in FIG. 2), which as a result sinks a comparatively long way into the slack runs 17a of the first belts 12a which wrap around the tensioning gear 11 on the other side with regard to its rotational axis 15 and consequently tensions these first belts 12a.

With a reversal of the rotational direction for the drive gear 8 according to FIG. 3, this tensioning effect is altered so that the strands, then acting as load strands 16a, 16b and wrapping around the tensioning gear 11 (which are located at the bottom in FIG. 3 with regard to the rotational axes 13, 14 of the drive gear 8 and the driven gear 10), load the tensioning gear 11 in the direction of an increasing sinking into the slack strand 17b of the second belt 12b.

As is gathered from FIG. 4, the belt width of the second belt 12b corresponds approximately to double the individual belt widths of the two first belts 12a, as a result of which the contact areas, which on the one hand the two first belts 12a form together and on the other hand the second belt 12b forms both with the drive gear 8, the driven gear 10 and, when the belt drive 7 is not in operation, the tensioning gear 11, are basically of equal size. As a result, in particular a transmission of basically equal value of the drive power in the two rotational directions of the drive gear 8 can be realized.

FIGS. 5 and 6 show two possible embodiments for a tensioning gear 11 of a belt drive 7 according to the invention.

The tensioning gear 11 according to FIG. 5 is designed basically as a simple solid cylinder in this case. As is also shown in FIG. 5, two circumferential grooves 18 can be introduced into the generated surface of the solid cylinder and can serve for accommodating encompassing boundary walls (not shown) by means of which the three belts 12a, 12b can be held in position with regard to the longitudinal extent of the tensioning gear 11.

Corresponding boundary walls can also be fastened on the two end faces of the solid cylinder for this. A tensioning gear 11 according to FIG. 5 can be simply designed as a rotating component. For reducing the mass of such a tensioning gear 11 this can also partially, or preferably over its entire longitudinal extent, be hollow and therefore of tubular design.

The tensioning gear 11 according to FIG. 6 in contrast comprises a shaft 19 and a roller 20 in each case, rotatably mounted on the shaft 19, for each of the belts 12a, 12b. A longitudinal axial securing of the rollers 20 on the shaft 19 can be carried for example by means of spring rings 21 which engage in circumferential grooves of the shaft 19, as is shown in FIG. 6. By providing an individual roller 20 for each of the belts 12a, 12b, slightly varying circumferential speeds at which these are moved with regard to the rotational axis 15 of the tensioning gear 11 can be compensated in a basically slip-free manner. A mounting of the rollers 20 on the shaft 19 can be carried out via pivot bearing elements 22, such as roller bearings (cf. FIG. 4).

A longitudinal axial securing of the belts on the individual rollers can in turn be carried out by means of boundary walls (not shown) which are fastened on the end face on the individual rollers. An alternative possibility for this, which can naturally also be applied in the case of the tensioning gear 11 according to FIG. 5, lies in crowning of the individual generated surface sections of the tensioning gear 11, or of the rollers 20 for it, which are provided for contact with the belts 12a, 12b. Naturally, crowning in combination with boundary walls can also be provided in order to secure the belts 12a, 12b in the longitudinal axial direction of the respective tensioning gear 11.

### LIST OF DESIGNATIONS

1 Steering rod

2 Steering spindle

3 Track rod end

4 Electric motor

5 Steering drive

6 Control unit

7 Belt drive

8 Drive gear

9 Housing

10 Driven gear

11 Tensioning gear

12a First belt

12b Second belt

13 Rotational axis of the drive gear

14 Rotational axis of the driven gear

15 Longitudinal axis/rotational axis of the tensioning gear

16a Load strand of a first belt

16b Load strand of the second belt

17a Slack strand of a first belt

17b Slack strand of the second belt

18 Circumferential groove

19 Shaft

20 Roller

21 Spring ring

22 Pivot bearing element

1. A belt drive (7) with a drive gear (8), a driven gear (10) and a tensioning gear (11), characterized by at least two belts (12a, 12b) which in each case partially wrap around the drive gear (8), the driven gear (10) and, by one strand in each case, the tensioning gear (11), wherein a first belt (12a), by the associated strand which extends from the drive gear (8) to the driven gear (10), wraps around the tensioning gear (11) in one of the circumferential directions, and a second belt (12b), by the associated strand which extends from the drive gear (8) to the driven gear (10), wraps around the tensioning gear (11) in the other circumferential direction.

2. The belt drive (7) as claimed in claim 1, characterized in that the belts (12a, 12b) are of toothless design.

3. The belt drive (7) as claimed in claim 2, characterized in that the belts (12a, 12b) are designed as flat belts.

4. The belt drive (7) as claimed in one of the preceding claims, characterized in that at least two first belts (12a) and one or more second belts (12b) are provided, wherein two first belts (12a) encompass the second belt(s) (12b) with regard to the direction of the longitudinal direction (15) of the tensioning gear (11).

5. The belt drive (7) as claimed in one of the preceding claims, characterized in that the contact areas, which on the one hand are formed in each case between the tensioning gear (11), the drive gear (8) and/or the driven gear (10) and also the first belt(s) (12a) and on the other hand are formed in each case between the tensioning gear (11), the drive gear (8) and/or the driven gear (11) and also the second belt(s) (12b), are of equal size.

6. The belt drive (7) as claimed in one of the preceding claims, characterized in that the tensioning gear (11) is supported exclusively by the belts (12a, 12b).

7. The belt drive (7) as claimed in one of the preceding claims, characterized by a drive motor, coupled to the drive gear (8), which is provided for a drive in both rotational directions.

8. A steering system with a steering rod (1) which is provided with one or more connecting elements which are intended for a connection to a wheel steering lever of a steerable wheel, and with a steering drive (5) which acts directly or indirectly upon the steering rod (1) and has a drive motor and a belt drive (7) according to the invention.

9. The steering system as claimed in claim 8, characterized by a steering shaft which is connected via a gear to the steering rod (1) in such a way that a rotation of the steering shaft leads to a longitudinal axial translation of the steering rod (1).
